(19) United States
(12) Patent Application Publication
(10) Pub. No.: US 2004/0250005 A1
(43) Pub. Date: Dec. 9, 2004

(54) Multimode USB apparatus and method for switching same

(76) Inventor: Andy C. Wu, Tu-chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/830,197

(22) Filed: Apr. 21, 2004

(30) Foreign Application Priority Data
May 23, 2003 (TW) 92114080

(51) Int. Cl. G06F 13/00

(52) U.S. Cl. 710/313

(57) ABSTRACT

A portable USB apparatus (6) can be operated in any one of the following three modes: a memory operating mode, a wireless communication operating mode, and an interruption mode. The portable USB apparatus includes a USB interface module (66) for connecting to a USB interface of a host, a memory module (60) for reading and writing data, a wireless communication module (64) for accessing a wireless local area network (WLAN), and a switch module (62) for switching the memory module and the wireless communication module. The switch module includes a mechanical switch (620), a first analogical switch (622) and a second analogical switch (624). A method for switching the portable USB apparatus is also disclosed.

### BACKGROUND OF THE INVENTION

1. Field of the Invention

The present invention relates to a universal serial bus (USB) apparatus and a method for switching the USB apparatus, and particularly to a USB apparatus having several operating modes and a method for switching such a USB apparatus.

2. Background of the Invention

There are numerous devices connecting to hosts through USB ports, such as wireless network cards, modems, flash disks, scanners and printers. Generally, a host cannot provide enough USB ports for users who have a plurality of USB devices.

In order to overcome this problem, one approach is to use USB hubs. U.S. Pat. No. 5,784,581, entitled “Apparatus and Method for Operating a Peripheral Device as Either a Master Device or a Slave Device” and issued on Jul. 21, 1998, discloses a USB hub that provides a plurality of communication ports for connecting a host and a plurality of USB devices. FIG. 6 is a schematic diagram of an application environment of a routing architecture of a conventional USB hub 8. The USB hub 8 comprises a plurality of communication ports. The USB hub 8 connects to a host 9 through one of the communication ports, and connects with a plurality of USB devices 7 via other communication ports. Thus the USB hub 8 functions as an expanded USB interface of the host 9. The host 9 can simultaneously connect to a plurality of USB devices 7 through the USB hub 8, thereby providing a multi USB device routing architecture.

However, even though the host 9 can simultaneously use a plurality of USB devices 7 by use of the routing architecture of the USB hub 8, the combined USB devices 7 may draw more power than can be output by the host 9. The output of a typical USB interface of a host 9 is limited to a current of 500 milliamperes. If the total power drawn by the combined USB devices 7 exceeds this limit, a source of additional power must be incorporated into the architecture. In addition, some portable USB devices need be used alternately. In such case, one or another of the USB devices may need to be “hidden” from the host 9. With the above routing architecture, this is not feasible. Consequently, a portable USB apparatus having several operating modes and a switching method thereof are needed.

### SUMMARY OF THE INVENTION

Accordingly, a primary object of the present invention is to provide a portable USB apparatus having three operating modes.

Another object of the present invention is to provide a method for switching a portable USB apparatus having multiple operating modes.

In order to accomplish the above-mentioned primary object, the present invention provides a portable USB apparatus, which can be operated in any one of the following three modes: a memory operating mode, a wireless communication operating mode, and an interruption mode. The portable USB apparatus comprises a USB interface module for connecting to a USB interface of a host, a memory module for reading and writing data, a wireless communication module for accessing a wireless local area network (WLAN), and a switch module for switching the memory module and the wireless communication module. The switch module comprises a mechanical switch, a first analogical switch, and a second analogical switch. The mechanical switch is for controlling switching between the first analogical switch and the second analogical switch.

When in memory operating mode, the portable USB apparatus functions as a portable USB memory; when in wireless communication operating mode, the portable USB apparatus functions as a portable wireless apparatus; and when in interruption mode, the portable USB apparatus maintains a connection with a host in a “sleeping” mode, waiting to be switched to memory operating mode or wireless communication operating mode.

In order to accomplish the other above-mentioned object, the present invention provides a method for switching the above-described USB apparatus. The method comprises the following steps: (a) selecting an operating mode parameter for the USB apparatus, the operating mode parameters comprising a memory operating parameter, a wireless communication operating parameter and an interruption mode parameter; and (b) if the memory operating parameter is selected: (b1) switching a mechanical switch to a memory port, and enabling a first analogical switch to drive a memory module; and (b2) setting up communication between a USB interface module and the memory module; (c) if the wireless communication operating parameter is selected: (c1) switching the mechanical switch to a wireless communication port, and enabling a second analogical switch to drive a wireless communication module; and (c2) setting up communication between the USB interface module and the wireless communication module; and

(d) if the interruption mode parameter is selected: (d1) switching the mechanical switch to an interruption port; and (d2) interrupting a memory operating mode or a wireless communication operating mode of the USB apparatus.

Unlike conventional apparatuses and methods for simultaneously using a plurality of USB devices with a USB hub, the present invention can alternately utilize different functions of a single USB apparatus. That is, a user need only operate one USB apparatus in order to read and write data, and to access a wireless local area network.

Other objects, advantages and novel features of the present invention will be drawn from the following detailed description of a preferred embodiment and preferred methods of the present invention with the attached drawings, in which:

### BRIEF DESCRIPTION OF THE DRAWINGS

FIG. 1 is a schematic diagram of infrastructure of a USB apparatus according to the present invention;

FIG. 2 is a data flow chart of the USB apparatus according to the present invention;

FIG. 3 is a flow chart of a preferred method for switching the USB apparatus to memory operating mode;

FIG. 4 is a flow chart of a preferred method for switching the USB apparatus to wireless communication operating mode;

FIG. 5 is a flow chart of a preferred method for switching the USB apparatus to interruption mode; and

FIG. 6 is a schematic diagram of an application environment of a routing architecture of a conventional USB hub.

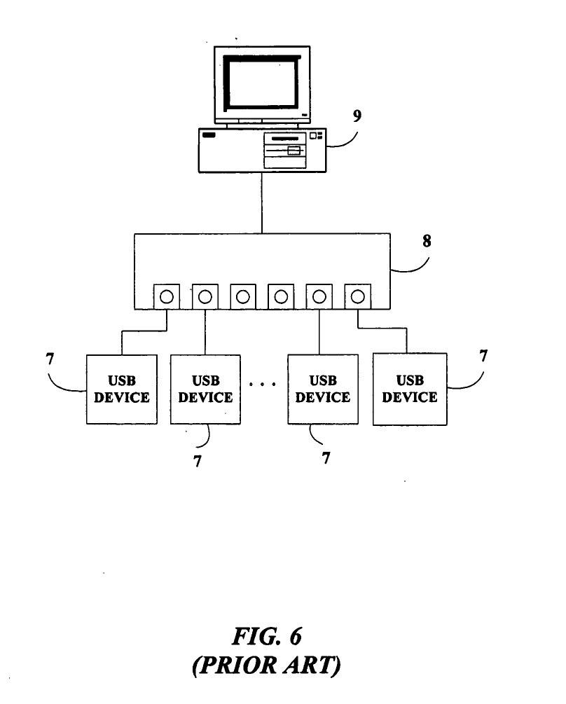

### DETAILED DESCRIPTION OF PREFERRED EMBODIMENTS

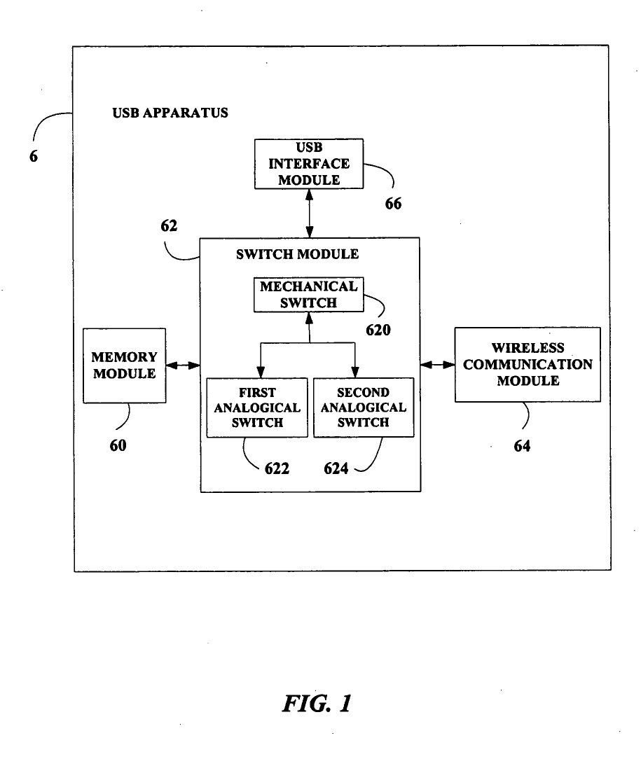

FIG. 1 is a schematic diagram of infrastructure of a USB apparatus 6 according to the present invention. The USB apparatus 6 can be operated in any one of the following three modes: a memory operating mode, a wireless communication operating mode, and an interruption mode. A default operating mode of the USB apparatus 6 is memory operating mode. The operating mode of the USB apparatus 6 can be switched among the above-mentioned three modes by use of a switch module 62 of the USB apparatus 6. When in memory operating mode, the USB apparatus 6 functions as a USB memory. When in wireless communication operating mode, the USB apparatus 6 functions as a wireless apparatus. When in interruption mode, the USB apparatus 6 maintains a connection with a host in a “sleeping” mode, waiting to be switched to memory operating mode or wireless communication operating mode.

The USB apparatus 6 of the present invention comprises a memory module 60 for reading and writing data, the switch module 62, a wireless communication module 64 for accessing a wireless local area network (WLAN), and a USB interface module 66. The memory module 60, the wireless communication module 64, and the USB interface module 66 connect with the switch module 62 in duplex mode. The switch module 62 comprises a mechanical switch 620, a first analogical switch 622, and a second analogical switch 624. The mechanical switch 620 further comprises a memory port, a wireless communication port, and an interruption port (not shown). When the mechanical switch 620 is switched to the memory port, this sets up communication between the first analogical switch 622 and the memory module 60, and the USB apparatus 6 operates in memory operating mode. When the mechanical switch 620 is switched to the wireless communication port, this sets up communication between the second analogical switch 624 and the wireless communication module 64, and the USB apparatus 6 operates in wireless communication operating mode. When the mechanical switch 620 is switched to the interruption port, this interrupts a memory operating mode or a wireless communication operating mode of the USB apparatus 6, and the USB apparatus 6 operates in interruption mode. The USB apparatus 6 connects with the host's USB interface (not shown) through the USB interface module 66, and obtains power from USB channels.

In the preferred embodiment of the present invention, the memory module 60 can be a flash memory, an electrically erasable programmable read only memory (EEPROM), or any other non-volatile memory. The wireless communication module 64 can be an MP3 (Moving Picture Experts Group, audio layer 3) module, an RFID (radio frequency identifier) module, or the like.

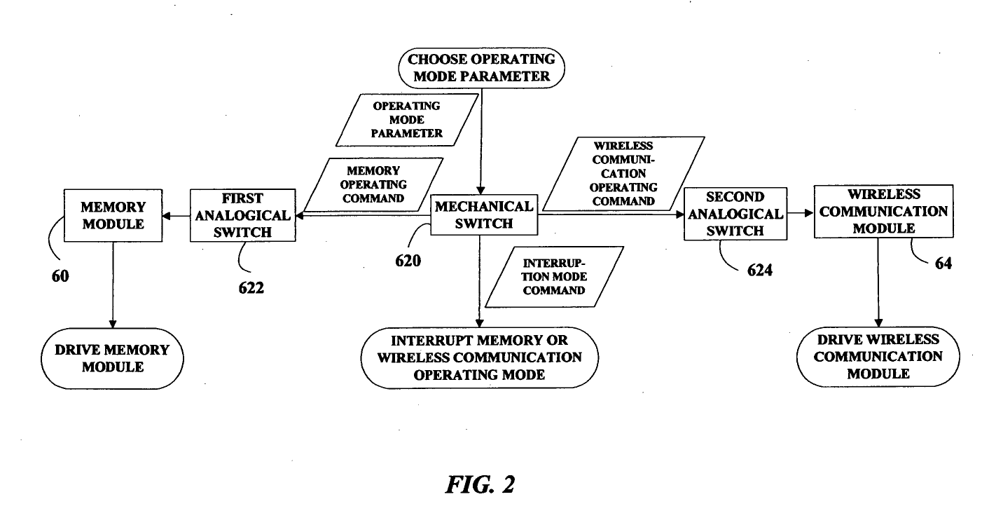

FIG. 2 is a data flow chart of the USB apparatus 6, in accordance with the present invention. When using the USB apparatus 6, a user selects an operating mode parameter. The operating mode parameters comprise a memory operating parameter, a wireless communication operating parameter, and an interruption mode parameter. According to the selected operating mode parameter, the user switches the mechanical switch 620 manually. Then the mechanical switch 620 generates a corresponding operating command. The operating command is either a memory operating command, a wireless communication operating command, or an interrupt mode command.

When the operating command is the memory operating command, the mechanical switch 620 transmits the memory operating command to the first analogical switch 622, which enables the first analogical switch 622 to drive the memory module 60. The USB apparatus 6 then functions as a USB memory. When the operating command is the wireless communication operating command, the mechanical switch 620 transmits the wireless communication operating command to the second analogical switch 624, which enables the second analogical switch 624 to drive the wireless communication module 64. The USB apparatus 6 then functions as a wireless apparatus. When the operating command is the interrupt mode command, the mechanical switch 620 interrupts a current memory operating mode or wireless communication operating mode of the USB apparatus 6. The USB apparatus 6 then maintains a connection with the host in a “sleeping” mode, waiting to be switched to memory operating mode or wireless communication operating mode.

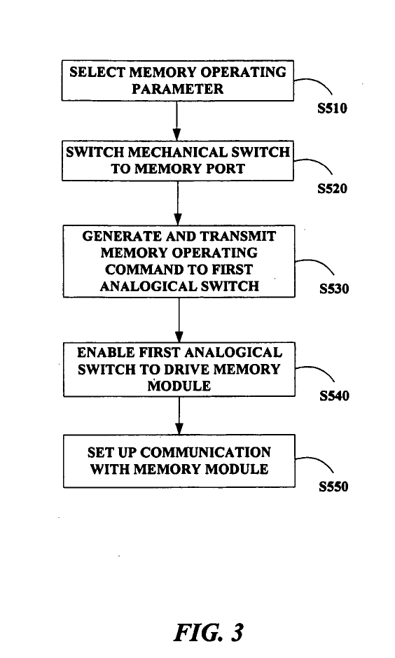

FIG. 3 is a flow chart of a preferred method for switching the USB apparatus 6 to memory operating mode. At step S510, the user selects the memory operating parameter. At step S520, the user switches the mechanical switch 620 to the memory port manually, according to the selected memory operating parameter. At step S530, the mechanical switch 620 generates a memory operating command, and transmits the memory operating command to the first analogical switch 622. At step S540, the mechanical switch 620 enables the first analogical switch 622 to drive the memory module 60, according to the memory operating command. At step S550, the USB interface module 66 sets up communication with the memory module 60.

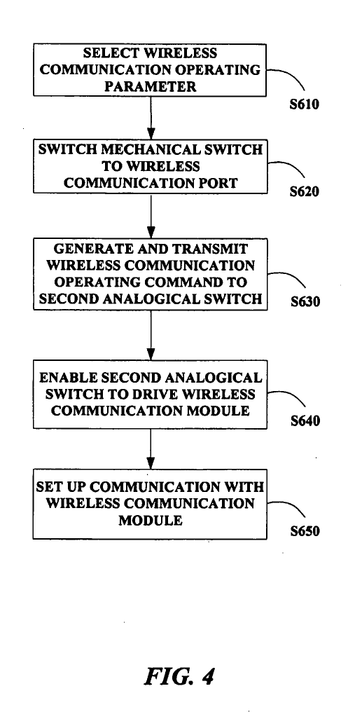

FIG. 4 is a flow chart of a preferred method for switching the USB apparatus 6 to wireless communication operating mode. At step S610, the user selects the wireless communication operating parameter. At step S620, the user switches the mechanical switch 620 to the wireless communication port manually, according to the selected wireless communication operating parameter. At step S630, the mechanical switch 620 generates a wireless communication operating command, and transmits the wireless communication operating command to the second analogical switch 624. At step S640, the mechanical switch 620 enables the second analogical switch 624 to drive the wireless communication module 64, according to the wireless communication operating command. At step S650, the USB interface module 66 sets up communication with the wireless communication module 64.

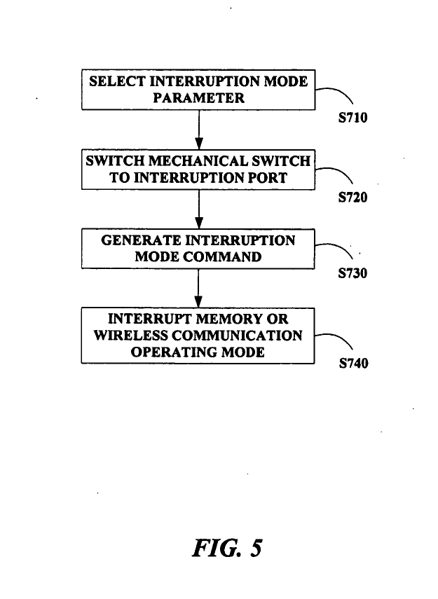

FIG. 5 is a flow chart of a preferred method for switching the USB apparatus 6 to interruption mode. At step S710, the user selects the interruption mode parameter. At step S720, the user switches the mechanical switch 620 to the interruption port manually, according to the selected interruption mode parameter. At step S730, the mechanical switch 620 generates an interrupt mode command. At step S740, the mechanical switch 620 interrupts a current memory operating mode or wireless communication operating mode of the USB apparatus 6, according to the interrupt mode command.

While a preferred embodiment and preferred methods of the present invention have been described above, it should be understood that they have been presented by way of example only and not by way of limitation. Thus the breadth and scope of the present invention should not be limited by the above-described exemplary embodiment and methods, but should be defined only in accordance with the following claims and their equivalents.

What is claimed is:

1. A universal serial bus (USB) apparatus comprising:
a USB interface module for connecting to a USB interface of a host;
a first USB module;
a second USB module; and
a switch module for switching the first USB module and the second USB module, the switch module comprising:
a mechanical switch;
a first analogical switch for connecting with the first USB module; and
a second analogical switch for connecting with the second USB module;
wherein the mechanical switch is for controlling switching between the first analogical switch and the second analogical switch.

2. The USB apparatus as claimed in claim 1, wherein the first USB module is a memory module for reading and writing data.

3. The USB apparatus as claimed in claim 2, wherein the second USB module is a wireless communication module for accessing a wireless local area network.

4. The USB apparatus as claimed in claim 3, wherein the USB apparatus can be operated in any one of the following three modes: a memory operating mode, a wireless communication operating mode, and an interruption mode.

5. The USB apparatus as claimed in claim 2, wherein the memory module for reading and writing data is a flash memory or an electrically erasable programmable read only memory.

6. The USB apparatus as claimed in claim 1, wherein the second USB module is an MP3 (Moving Picture Experts Group, audio layer 3) module or a radio frequency identifier module.

7. The USB apparatus as claimed in claim 1, wherein the mechanical switch comprises a memory port, a wireless communication port and an interruption port.

8. The USB apparatus as claimed in claim 4, wherein when the mechanical switch is switched to the memory port, this sets up communication between the first analogical switch and the memory module, and the USB apparatus operates in memory operating mode.

9. The USB apparatus as claimed in claim 4, wherein when the mechanical switch is switched to the wireless communication port, this sets up communication between the second analogical switch and the wireless communication module, and the USB apparatus operates in wireless communication operating mode.

10. The USB apparatus as claimed in claim 4, wherein when the mechanical switch is switched to the interruption port, this interrupts memory operating mode or wireless communication operating mode, and the USB apparatus operates in interruption mode.

11. A universal serial bus (USB) apparatus comprising:
a USB interface module for connecting to a USB interface of a host;
a memory module for reading and writing data;
at least a USB module; and
a switch module for switching the memory module and said USB module, the switch module further comprising:
a mechanical switch;
a first analogical switch for connecting with the memory module; and
a second analogical switch for connecting with said USB module;
wherein the mechanical switch is for controlling switching between the first analogical switch and the second analogical switch.

12. The USB apparatus as claimed in claim 11, wherein said USB module is a wireless communication module for accessing a wireless local area network.

13. The USB apparatus as claimed in claim 12, wherein the USB apparatus can be operated in any one of the following three modes: a memory operating mode, a wireless communication operating mode, and an interruption mode.

14. The USB apparatus as claimed in claim 11, wherein the memory module for reading and writing data is a flash memory or an electrically erasable programmable read only memory.

15. The USB apparatus as claimed in claim 11, wherein said USB module is an MP3 (Moving Picture Experts Group, audio layer 3) module or a radio frequency identifier module.

16. The USB apparatus as claimed in claim 11, wherein the mechanical switch comprises a memory port, a wireless communication port and an interruption port.

17. The USB apparatus as claimed in claim 13, wherein when the mechanical switch is switched to the memory port, this sets up communication between the first analogical switch and the memory module, and the USB apparatus operates in memory operating mode.

18. The USB apparatus as claimed in claim 13, wherein when the mechanical switch is switched to the wireless communication port, this sets up communication between the second analogical switch and the wireless communication module, and the USB apparatus operates in wireless communication operating mode.

19. The USB apparatus as claimed in claim 13, wherein when the mechanical switch is switched to the interruption port, this interrupts memory operating mode or wireless communication operating mode, and the USB apparatus operates in interruption mode.

20. A method for switching a universal serial bus (USB) apparatus, the method comprising the following steps:
(a) selecting an operating mode parameter for the USB apparatus, the operating mode parameters comprising a memory operating parameter, a wireless communication operating parameter and an interruption mode parameter; and
(b) if the memory operating parameter is selected:
(b1) switching a mechanical switch to a memory port, and enabling a first analogical switch to drive a memory module; and
(b2) setting up communication between a USB interface module and the memory module;
(c) if the wireless communication operating parameter is selected:
(c1) switching the mechanical switch to a wireless communication port, and enabling a second analogical switch to drive a wireless communication module; and
(c2) setting up communication between the USB interface module and the wireless communication module; and
(d) if the interruption mode parameter is selected:
(d1) switching the mechanical switch to an interruption port; and
(d2) interrupting a memory operating mode or a wireless communication operating mode of the USB apparatus.
